(19) United States
(12) Patent Application Publication
(10) Pub. No.: US 2012/0320226 A1
(43) Pub. Date: Dec. 20, 2012

(54) STATIONARY PRINTING APPARATUS WITH CAMERA

(76) Inventors: Chee Meng Chen, Singapore (SG); Gary A. Kneezel, Webster, NY (US)

(21) Appl. No.: 13/159,527

(22) Filed: Jun. 14, 2011

(51) Int. Cl. H04N 5/225

(52) U.S. Cl. 348/207.2; 348/E05.024

(57) ABSTRACT

A stationary printing apparatus includes a display; a camera to capture an image, the camera being mounted proximate the display; and a printing mechanism configured to print the image.

### FIELD OF THE INVENTION

The present invention relates generally to a printing apparatus, and more particularly to a printing apparatus including image capture capability.

### BACKGROUND OF THE INVENTION

In recent years the image quality available even from printers intended for home use, such as desktop inkjet printers, has advanced to the point where high quality photographic images can easily be printed in a variety of common sizes, including 4″×6″ and 8″×10″. The source of such images is typically from the user's digital camera, or from digital photographs provided by friends and family by e-mailing to a computer connected to the printer or read from a memory card inserted into the computer or the printer itself, or downloaded from the internet.

Typically a digital image is captured by a person taking a picture of a region including people or objects other than the person taking the picture. When the person taking the picture wants to be in the photograph, he can point the camera at himself at arm's length, or set a timer on the camera, put the camera down, and walk to the place where the camera is pointed. These approaches can work, but they are not always satisfactory. For example if one needs to take a self portrait having strict image specifications, such as a passport photo, holding a camera at arm's length will typically not provide a suitable image, and it may take several tries to produce a suitable image using a camera with a timer. Similarly, taking a self portrait together with a less well-controlled subject, such as a small child or a pet can provide unsatisfying results or frustration using such means as a camera at arm's length or a camera with a timer.

In addition, it can sometimes be complex to transfer the digital image from the camera to a printer for printing. Some cameras come with a printing mechanism integrated into the camera. See, for example, U.S. Pat. No. 6,091,909. However, such devices are limited in how large an image they are able to print, especially since the tendency is for cameras to be smaller and light weight so that they are more portable. Such devices also are typically able to store only a small quantity of the printing supplies that are needed, so not many pictures can be taken and then printed.

What is needed is an image capture and printing apparatus that makes it easy for a user to include himself in pictures that he takes, and also easy to print the resultant image.

### SUMMARY OF THE INVENTION

The present invention is directed to overcoming one or more of the problems set forth above. Briefly summarized, according to one aspect of the invention, the invention resides in a stationary printing apparatus having a display; a camera to capture an image, the camera being mounted proximate the display; and a printing mechanism configured to print the image.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic representation of an inkjet printer system;

FIG. 2 is a perspective view of a portion of a printhead chassis;

FIG. 3 is a perspective view of a portion of a carriage printer;

FIG. 4 is a schematic side view of an exemplary paper path in a carriage printer;

FIG. 5 is a perspective view of a stationary printing apparatus with a camera according to a first embodiment;

FIG. 6 is a perspective view of a stationary printing apparatus with two cameras for stereographic image capture and printing according to a second embodiment; and

FIG. 7 is a perspective view of a stationary printing apparatus with two cameras for stereographic image capture and printing according to a third embodiment

### DETAILED DESCRIPTION OF THE INVENTION

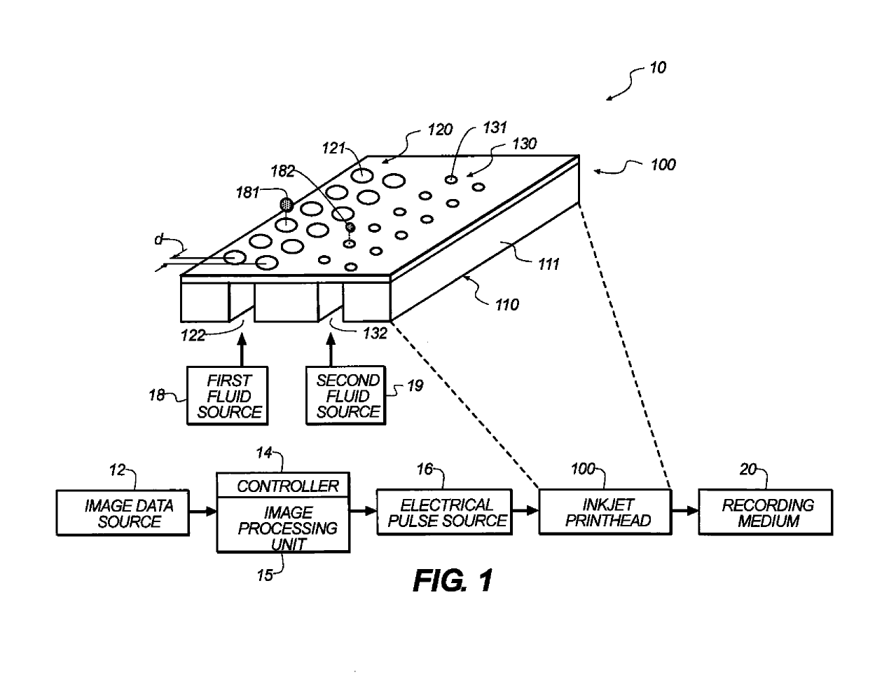

Referring to FIG. 1, a schematic representation of an inkjet printer system 10 is shown, for its usefulness with the present invention and is fully described in U.S. Pat. No. 7,350,902, and is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays.

Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density then in each array is 1200 per inch (i.e. d= 1/1200 inch in FIG. 1). If pixels on the recording medium 20 were sequentially numbered along the paper advance direction, the nozzles from one row of an array would print the odd numbered pixels, while the nozzles from the other row of the array would print the even numbered pixels.

In fluid communication with each nozzle array is a corresponding ink delivery pathway. Ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through printhead die substrate 111. One or more inkjet printhead die 110 will be included in inkjet printhead 100, but for greater clarity only one inkjet printhead die 110 is shown in FIG. 1. In FIG. 1, first fluid source 18 supplies ink to first nozzle array 120 via ink delivery pathway 122, and second fluid source 19 supplies ink to second nozzle array 130 via ink delivery pathway 132. Although distinct fluid sources 18 and 19 are shown, in some applications it may be beneficial to have a single fluid source supplying ink to both the first nozzle array 120 and the second nozzle array 130 via ink delivery pathways 122 and 132 respectively. Also, in some embodiments, fewer than two or more than two nozzle arrays can be included on printhead die 110. In some embodiments, all nozzles on inkjet printhead die 110 can be the same size, rather than having multiple sized nozzles on inkjet printhead die 110.

Not shown in FIG. 1, are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

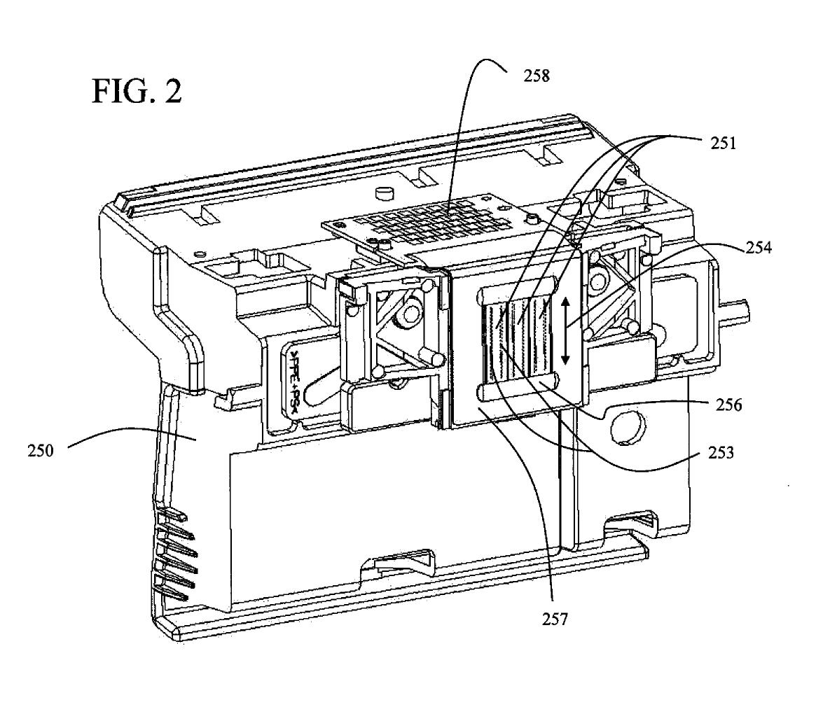

FIG. 2 shows a perspective view of a portion of a printhead chassis 250, which is an example of an inkjet printhead 100. Printhead chassis 250 includes three printhead die 251 (similar to printhead die 110 in FIG. 1), each printhead die 251 containing two nozzle arrays 253, so that printhead chassis 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead chassis 250 across the recording medium 20. Following the printing of a swath, the recording medium 20 is advanced along a media advance direction that is substantially parallel to nozzle array direction 254.

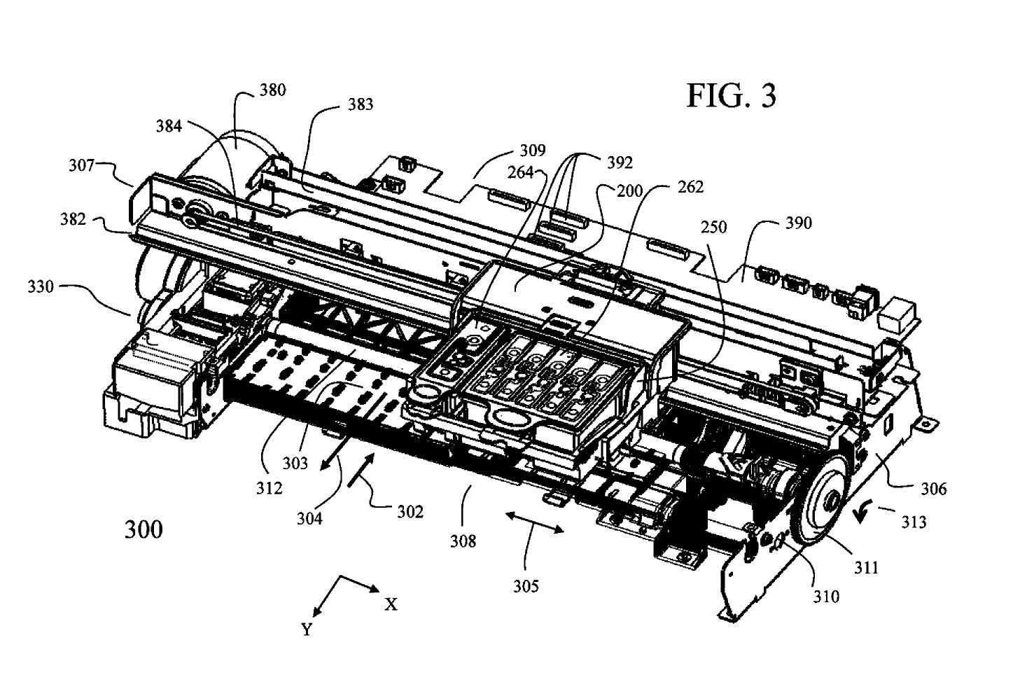

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead chassis 250 and connects to connector board 258. When printhead chassis 250 is mounted into the carriage 200 (see FIG. 3), connector board 258 is electrically connected to a connector (not shown) on the carriage 200, so that electrical signals can be transmitted to the printhead die 251.

FIG. 3 shows a portion of a desktop carriage printer. A desktop carriage printer is an example of a stationary printer, which is defined herein as a printer that is intended to be supported by a support structure, such as a desk or a table during operation. Although a stationary printer can be picked up and moved, it is not intended to be handheld or carried during operation.

Some of the parts of the printer have been hidden in the view shown in FIG. 3 so that other parts can be more clearly seen. Printing mechanism 300 has a print region 303 across which carriage 200 is moved back and forth in carriage scan direction 305 along the X axis, between the right side 306 and the left side 307 of printing mechanism 300, while drops are ejected from printhead die 251 (not shown in FIG. 3) on printhead chassis 250 that is mounted on carriage 200. Carriage motor 380 moves belt 384 to move carriage 200 along carriage guide rail 382. An encoder sensor (not shown) is mounted on carriage 200 and indicates carriage location relative to an encoder fence 383.

Printhead chassis 250 is mounted in carriage 200, and multi-chamber ink supply 262 and single-chamber ink supply 264 are mounted in the printhead chassis 250. The mounting orientation of printhead chassis 250 is rotated relative to the view in FIG. 2, so that the printhead die 251 are located at the bottom side of printhead chassis 250, the droplets of ink being ejected downward onto the recording medium in print region 303 in the view of FIG. 3. Multi-chamber ink supply 262, in this example, contains five ink sources: cyan, magenta, yellow, photo black, and colorless protective fluid; while single-chamber ink supply 264 contains the ink source for text black. Paper or other recording medium (sometimes generically referred to as paper or media herein) is loaded along paper load entry direction 302 toward the front of printing mechanism 308.

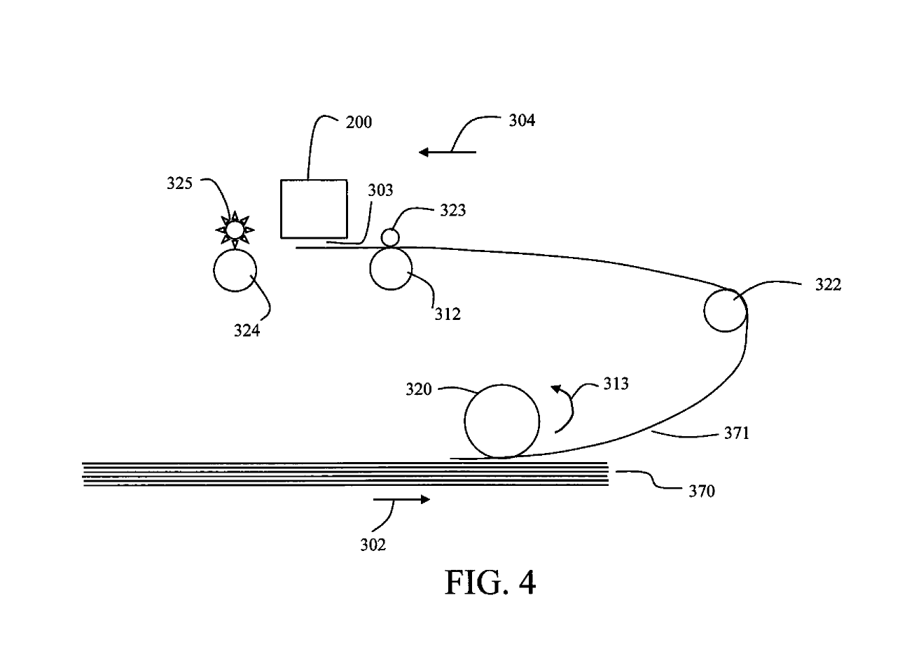

A variety of rollers are used to advance the medium through the printer as shown schematically in the side view of FIG. 4. In this example, a pick-up roller 320 moves the top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along media advance direction 304 from the rear 309 of the printing mechanism (with reference also to FIG. 3). The paper is then moved by feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 3, but the hole 310 at the right side of the printing mechanism 306 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the left side of the printing mechanism 307, in the example of FIG. 3, is the maintenance station 330. Toward the rear of the printing mechanism 309, in this example, is located the electronics board 390, which includes cable connectors 392 for communicating via cables (not shown) to the printhead carriage 200 and from there to the printhead chassis 250. Also on the electronics board are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

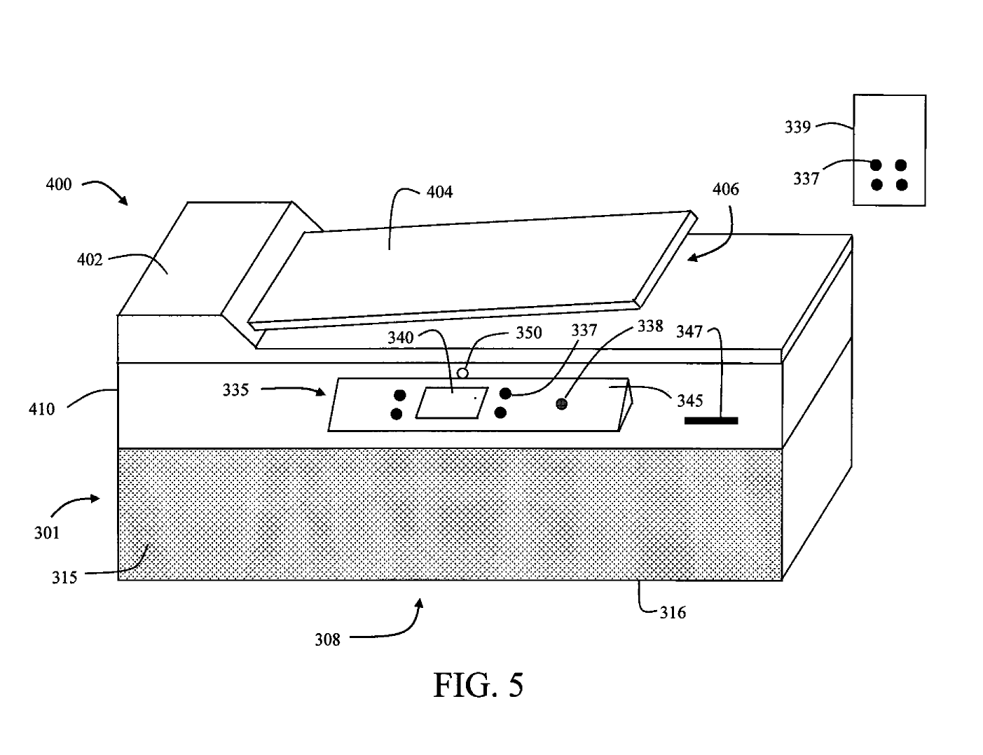

An embodiment of the present invention is shown in FIG. 5. Stationary printing apparatus 301 includes a printing mechanism for printing images, such as printing mechanism 300 (FIG. 3), enclosed within a housing 315. A base 316 of stationary printing apparatus 301 sits on a support structure such as a desktop or table during operation. Stationary printing apparatus 301 includes a display 340 and a camera 350 for capturing images (where the camera 350 is mounted near display 340). In the example shown in FIG. 5, stationary printing apparatus 301 includes a control panel 335 having control buttons 337 located on the same frame 345 on which the display 340 is located. Display 340 is viewable by a user who is looking at the front 308 of the stationary printing apparatus 301.

Camera 350 is mounted near display 340 so that as the viewer looks at the display 340, he is substantially also looking into the camera 350. Optionally, camera 350 is adjustably mounted near display 340, so that the camera can be adjusted (manually or by motor) into different orientations for panning to capture different views.

In the example of FIG. 5, stationary printing apparatus 301 is part of a multifunction printer 400 that also includes a scanning apparatus 410 for scanning documents or other items, but stationary printing apparatus 301 could alternatively be a single function printer. Also shown in FIG. 5 is an automatic document feeder 402 for feeding documents for scanning from an input tray 404, past a scanning window (not shown) and into an output tray 406.

Associated with stationary printing apparatus 301 (and also with scanning apparatus 410 in the case of a multifunction printer 400) is a control panel 335 with one or more control buttons 337 for controlling the operation. Control buttons 337 can be separate from display 340, or in the case of a touch screen, one or more control buttons can be integrated into display 340. One or more control buttons 337 can optionally be used to operate camera 350. Alternatively, a remote control 339 can be associated with camera 350 so that the user does not need to be within arm's reach of stationary printing apparatus 301 when taking a picture with camera 350. Remote control 339 can include one or more control buttons 337 for controlling camera functions such as taking a picture, adjusting the zoom or panning. A receiver 338 is shown in FIG. 5 for receiving a signal (such as an infrared signal) from the remote control 339. In the example of FIG. 5, display 340, control panel 335 and receiver 338 are all mounted on a frame 345 that angles outwardly from the front 308 of the unit.

Images that are captured by camera 350 can be printed as described above relative to FIGS. 3 and 4. Alternatively, captured images can be stored in memory, such as in a memory device that is inserted into slot 347 shown in FIG. 5. Controller 14 (FIG. 1) can be used to control the functions of camera 350. In particular, controller 14 is configured to display a view on display 340 that is the view seen by camera 350, and then capture the view displayed on the display 350 as a captured image. Controller 14 can be further configured to display the captured image on the display 340 and process the captured image for printing on the printing mechanism 300 (FIG. 3). Controller 14 can further be configured to review a plurality of captured images on display 340, so that the user can select which image or images to print on printing mechanism 300. Such images can be displayed in sequential fashion on display 340, or a plurality of captured images can be reviewed at the same time on display 340 for side-by-side comparison.

In addition, controller 14 can be configured to manipulate the content of the image to be printed, using such photo editing functions as cropping, adjusting image size or orientation, removal of unwanted objects, red-eye reduction, brightness or contrast adjustment, color balance, selective color change, merging of images, addition of customized backgrounds or other special effects. For guiding the proper picture size for images such as passport photos, a template or outline can be displayed on the display 340 showing how big the head size should be and where it should be positioned. There can also be post processing for passport photos such as cropping details and printing two images per 4×6 sheet. Fun aspects can also be provided in a library of backgrounds such as landscape backgrounds that can be merged or superposed into the captured images. For photos of two subjects side by side there can be morphing software for gradually morphing one face into the other. The controller 14 can also be configured to display the image with manipulated content on the display 340 prior to printing so that the user can see what the printed image will look like. Some of the functions mentioned above can alternatively be provided by software in a host computer, and displayed on a display that is associated with the host computer. However, by including the processing capability in controller 14 and the display capability in display 340, stationary printing mechanism 301 can function as a stand-alone image capture and printing apparatus.

Controller 14 can also be configured to control the operation of the camera 350. For example, controller 14 can be configured to control camera 350 to capture a sequence of a predetermined number of images at predetermined time intervals. Such a function can be helpful, for example, for taking a self portrait together with a less well-controlled subject such as a small child or a pet. The sequence of images can be captured using substantially the same conditions, such as exposure time. Alternatively, the sequence of images can be captured using different conditions.

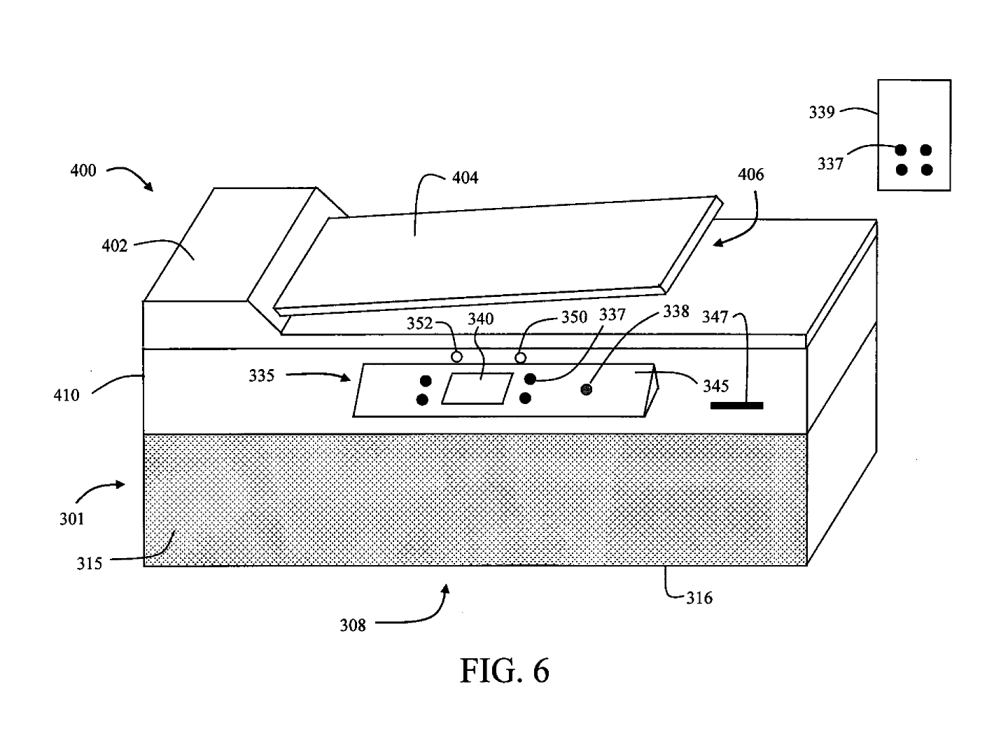

A second embodiment is shown in FIG. 6, in which a first camera 350 and a second camera 352 are mounted near display 340, such that the first camera 350 and the second camera 352 are separated from each other (typically by several inches) in order to capture stereographic images, i.e. images having a three dimensional appearance when viewed under appropriate viewing conditions. Recent printers, such as the Kodak ESP 310 printer, include associated software for processing two photos into one 3D anaglyph image that can be viewed with special glasses having one red filter and one cyan filter to provide a 3D image. However, in order to provide the two photos for the Kodak ESP 310 printer, a standard digital camera is used to take a first photo. Then the standard digital camera is moved to the right a few inches and the second photo is taken. This approach is satisfactory if subject in the photo is not moving, but the resulting image can become blurred if the subject is moving. Stereographic cameras including two cameras are already available for taking two images simultaneously, but typically such stereographic cameras are handheld and not incorporated together with a printing apparatus. As a result, the embodiment shown in FIG. 6 is particularly advantageous for the capture and printing of 3D images where the person taking the picture is part of the desired 3D image. Optionally, the spacing between first camera 350 and second camera 352 is adjustable for proper 3D imaging of subjects at different distances from stationary printing apparatus 301.

Controller 14 of FIG. I can be configured to control the image capture process for the two cameras 350 and 352 of the embodiment shown in FIG. 6. Controller 14 can be configured to display a view as seen by first camera 350 (e.g. on display 340), and then capture a composite view by the first camera 350 and the second camera 352 as a captured stereographic image. In addition, controller 14 can be configured to process the stereographic image for printing as a printed image having a three-dimensional appearance when viewed with the appropriate viewing conditions. For example, an anaglyph image can be provided for viewing with special glasses having red and cyan filters as described above, but other types of 3D images appropriate for other types of viewing conditions can alternatively be provided. In order for the user to see the 3D image before printing it, the controller can be configured to display a composite view as seen by the first camera and the second camera. Typically the composite view would be displayed (for example on display 340) after image capture so that the user could view the image using the special glasses, but without the special glasses being included in the photograph. Further, the controller 14 can be configured to process the stereographic image seen on the display for printing as a printed image having a three-dimensional appearance when viewed with the appropriate viewing conditions.

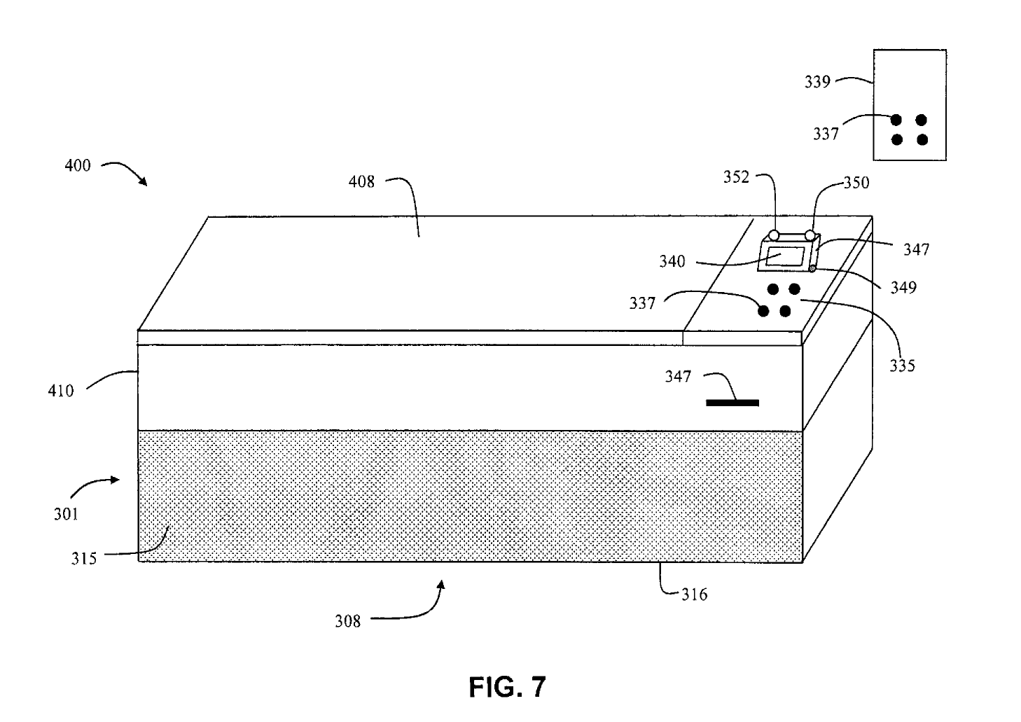

A third embodiment of the present invention is shown in FIG. 7. In this embodiment, multifunction printer 400 does not include an automatic document feeder, but rather has a lid 408 that covers the scanning apparatus 410. A document can be placed manually on the scanner glass (not shown) by raising the lid 408. In this example, the display 340, the cameras 350 and 352, and the control panel 335 with control buttons 337 are mounted on an upper surface of the housing 315 of multifunction printer 400, rather than at the front 308 of the unit. In addition, the display 340 is located within a frame 345 that is adjustably mounted on the housing 315 by a hinge or swivel 349. Further, the cameras 350 and 352 are also mounted on frame 345, so that the orientation of the cameras 350 and 352 and the display 340 relative to housing 315 can be adjusted. First camera 350 and second camera 352 of the embodiment shown in FIG. 7 allow capture of stereographic images as described above relative to FIG. 6. In an alternative embodiment (not shown), a single camera 350 could be incorporated, without the second camera 352.

The invention has been described in detail with particular reference to certain preferred embodiments thereof, but it will be understood that variations and modifications can be effected within the spirit and scope of the invention.

### PARTS LIST

10 Inkjet printer system

12 Image data source

14 Controller

15 Image processing unit

16 Electrical pulse source

18 First fluid source

19 Second fluid source

20 Recording medium

100 Inkjet printhead

110 Inkjet printhead die

111 Substrate

120 First nozzle array

121 Nozzle(s)

122 Ink delivery pathway (for first nozzle array)

130 Second nozzle array

131 Nozzle(s)

132 Ink delivery pathway (for second nozzle array)

181 Droplet(s) (ejected from first nozzle array)

182 Droplet(s) (ejected from second nozzle array)

200 Carriage

250 Printhead chassis

251 Printhead die

253 Nozzle array

254 Nozzle array direction

256 Encapsulant

257 Flex circuit

258 Connector board

262 Multi-chamber ink supply

264 Single-chamber ink supply

300 Printing mechanism

301 Printing apparatus

302 Paper load entry direction

303 Print region

304 Media advance direction

305 Carriage scan direction

306 Right side of printing mechanism

307 Left side of printing mechanism

308 Front of printing mechanism

309 Rear of printing mechanism

310 Hole (for paper advance motor drive gear)

311 Feed roller gear

312 Feed roller

313 Forward rotation direction (of feed roller)

315 Housing

316 Base

320 Pick-up roller

322 Turn roller

323 Idler roller

324 Discharge roller

325 Star wheel(s)

330 Maintenance station

335 Control panel

337 Control button

338 Receiver

339 Remote control

340 Display

345 Frame

347 Slot for memory device

349 Swivel or hinge

350 Camera

352 Camera

370 Stack of media

371 Top piece of medium

380 Carriage motor

382 Carriage guide rail

383 Encoder fence

384 Belt

390 Printer electronics board

392 Cable connectors

400 Multifunction printer

402 Automatic document feeder

404 Input tray

406 Output tray

408 Lid

410 Scanning apparatus

1. A stationary printing apparatus comprising:
a display;
a camera to capture an image, the camera being mounted proximate the display; and
a printing mechanism configured to print the image.

2. The stationary printing apparatus of claim 1, wherein the camera is adjustably mounted proximate the display so that the camera can be adjusted into different orientations.

3. The stationary printing apparatus of claim 1, wherein the display is adjustably mounted to a housing of the printer so that the orientation of the camera and the display relative to the housing of the printer can be adjusted.

4. The stationary printing apparatus of claim 1 further comprising a controller configured to:
display a view as seen by the camera; and
capture the view displayed on the display as a captured image.

5. The stationary printing apparatus of claim 4, the controller further being configured to:
display the captured image on the display; and
process the captured image for printing on the printing mechanism.

6. The stationary printing apparatus of claim 5, wherein the controller is further configured to review a plurality of captured images on the display so that the user can select which image(s) to print on the printing mechanism.

7. The stationary printing apparatus of claim 6, wherein the controller is configured to review a plurality of captured images in sequential fashion on the display.

8. The stationary printing apparatus of claim 6, wherein the controller is configured to review a plurality of captured images at the same time on the display.

9. The stationary printing apparatus of claim 5, wherein the controller is configured to manipulate the content of the image to be printed.

10. The stationary printing apparatus of claim 9, wherein the controller is configured to display the image with manipulated content on the display prior to printing.

11. The stationary printing apparatus of claim 4, wherein the controller is configured to control the camera to capture a sequence of images.

12. The stationary printing apparatus of claim 11, wherein the sequence of images is captured using substantially the same conditions.

13. The stationary printing apparatus of claim 11, wherein the sequence of images is captured using different conditions.

14. The stationary printing apparatus of claim 1, the camera being a first camera, the printer comprising a second camera mounted proximate the display and separated from the first camera.

15. The stationary printing apparatus of claim 14 further comprising a controller, wherein the controller is configured to
display a view as seen by the first camera; and
capture a composite view by the first camera and the second camera as a captured stereographic image.

16. The stationary printing apparatus of claim 15, the controller being configured to process the stereographic image for printing as a printed image having a three-dimensional appearance when viewed with the appropriate viewing conditions.

17. The stationary printing apparatus of claim 14 further comprising a controller, wherein the controller is configured to
display a composite view as seen by the first camera and the second camera.

18. The stationary printing apparatus of claim 17, the controller being configured to process the stereographic image for printing as a printed image having a three-dimensional appearance when viewed with the appropriate viewing conditions.

19. The stationary printing apparatus of claim 14, wherein a spacing between the first camera and the second camera is adjustable.

20. The stationary printing apparatus of claim 1, further comprising a receiver for a signal from a remote control.
